(19) United States
(12) Patent Application Publication
(10) Pub. No.: US 2023/0259154 A1
(43) Pub. Date: Aug. 17, 2023

(54) TRACKED VEHICLE COMPRISING A USER INTERFACE

(71) Applicant: PRINOTH S.P.A., Vipiteno (IT)

(72) Inventors: Richard Casartelli, Vipiteno (IT); Martin Kirchmair, Vipiteno (IT); Alberto Paoletti, Vipiteno (IT); Francesco Salis, Vipiteno (IT)

(21) Appl. No.: 17/777,505

(22) PCT Filed: Nov. 20, 2020
(86) PCT No.: PCT/IB2020/060970

§ 371 Date: May 17, 2022

(30) Foreign Application Priority Data
Nov. 22, 2019 (IT) 102019000021939

(51) Int. Cl. G05G 9/047; B62D 55/06; E01H 4/02; B60Q 9/00

(52) U.S. Cl. CPC G05G 9/047; B62D 55/06; E01H 4/02; B60Q 9/00; G05G 2009/04774; G05G 2009/0474

(57) ABSTRACT

Tracked vehicle comprising: a frame extending along a longitudinal axis; a plurality of tracks; at least an accessory device selected from a group comprising a blade, a tiller assembly and a winch assembly; and a user interface comprising a control device coupled to the plurality of tracks to drive the advance of the tracked vehicle; and a joystick coupled to the at least accessory device to drive the movements of the at least accessory device; wherein the joystick comprises a lever configured so that it can be move in any direction with respect to a rest position; wherein the joystick comprises a detector assembly to detect a movement of the lever with respect to the rest position and to emit an output signal based on the detected movement.

### PRIORITY CLAIM

This application is a national stage application of PCT/IB2020/060970, filed on Nov. 20, 2020, which claims the benefit of and priority to Italian Patent Application No. 102019000021939, filed on Nov. 22, 2019, the entire contents of which are each incorporated by reference herein.

### TECHNICAL FIELD

The present disclosure relates to a tracked vehicle comprising a user interface.

### BACKGROUND

A tracked vehicle, such as a snow groomer, generally comprising a shovel, a tiller and a winch; and a user interface comprising a joystick coupled to the at least accessory for driving the movements of the at least accessory. Generally, the joystick comprises a base, a lever coupled to the base and a detector assembly for detecting the movement of the lever with respect to a rest position, and a control unit for emitting an output signal based on the movement detected by the detector assembly.

The interfaces currently in use comprise a joystick having a deadband of values pre-set mechanically or electronically and not modifiable.

A drawback of certain of the prior art is that such a joystick can determine an output signal for involuntary movements of the lever of the joystick, consequently it can generate movements of one or more accessories that do not correspond to the will of the operator.

### SUMMARY

The object of the present disclosure is to provide a tracked vehicle, such as a snow groomer, that allows overcoming or at least mitigating certain of the drawbacks of certain of the prior art.

Therefore, according to the present disclosure a tracked vehicle is realised comprising: a frame extending along a longitudinal axis; a plurality of tracks; at least an accessory device selected from a group comprising a blade, a tiller assembly and a winch assembly; and a user interface comprising a control device coupled to the plurality of tracks for driving the advance of the tracked vehicle; and a joystick coupled to the at least accessory device for driving the movements of the at least accessory device; wherein the joystick comprises a lever configured so that the joystick can be moved in any direction with respect to a rest position; wherein the joystick comprises a detector assembly for detecting a movement of the lever with respect to the rest position and emitting an output signal based on the detected movement; the tracked vehicle comprising a control unit coupled to the at least accessory device for controlling at least a movement of said accessory device by a control signal sent to the at least accessory device; the control unit being coupled to the detector assembly of the joystick for receiving the output signal and being configured to define the control signal according to a first function and the output signal. In certain embodiments, said first function is a non-linear function. In certain embodiments, the parameters of said first function are adjustable according to further signals.

In certain embodiments, the first function can be adjusted dynamically by the control unit according to the further signals, such as relating to other inputs. In this way, it is possible to adjust dynamically the sensitivity of the joystick and make the joystick relatively immune or less sensitive to involuntary movements of the operator.

According to an embodiment, the first function is defined so that the control unit emits the control signal equal to zero or does not emit a control signal if the distance between the position of the lever and the rest position is within a designated or given displacement range; wherein the designated displacement range is dynamically adjustable. In certain embodiments, the control signal is obtained by the first function in the following manner: Sc=a*Su+k, where a and k are variable parameters and adjustable by the control unit, k is greater than zero and Su is the output signal.

In accordance with the present disclosure, the designated range is adjusted manually or automatically and this produces the effect of having an adjustable sensitivity, also automatically, such to have a great sensitivity to the voluntary commands of the operator and at the same time to be immune or less sensitive to the involuntary movements of the operator which in turn cause involuntary movements of the accessory devices.

Another object of the present disclosure is to provide a method for controlling an accessory of a tracked vehicle, in particular of a snow groomer, that reduces certain of the drawbacks of certain of the prior art.

According to the present disclosure, a method is provided for controlling an accessory of a tracked vehicle, the tracked vehicle comprising: two tracks; at least an accessory device selected from a group comprising a blade, a tiller assembly and a winch assembly; and a user interface comprising a control device coupled to the plurality of tracks for driving the advance of the tracked vehicle, and a joystick coupled to the at least accessory device for driving the movements of the at least accessory device; wherein the joystick comprises a lever configured so that the joystick can be moved in any direction with respect to a rest position; the method comprising the step of detecting a movement of the lever with respect to a rest position, and emitting an output signal according to the detected movement; the method comprising the step of controlling at least a movement of the at least accessory device based on a first function and the output signal. In certain embodiments, said first function is a non-linear function. In certain embodiments, the parameters of said first function are adjustable based on further signals.

### BRIEF DESCRIPTION OF THE DRAWINGS

Further features and advantages of the present disclosure will become apparent from the following description of non-limiting embodiment examples, with reference to the figures of the accompanying drawings, wherein:

FIG. 1 shows a lateral view of a tracked vehicle in accordance with an embodiment of the present disclosure;

FIG. 2 shows a perspective view of a joystick of the tracked vehicle of FIG. 1;

FIG. 3 shows a top view of the joystick of FIG. 2;

FIG. 4 shows a lateral view of the joystick of FIG. 2;

FIG. 5 shows a front view of the joystick of FIG. 2;

FIG. 6 is a block diagram of a detail of the tracked vehicle 1;

FIG. 7 shows a plurality of functions in accordance with the following disclosure; and

FIG. 8 shows another plurality of functions in accordance with the following disclosure.

### DETAILED DESCRIPTION

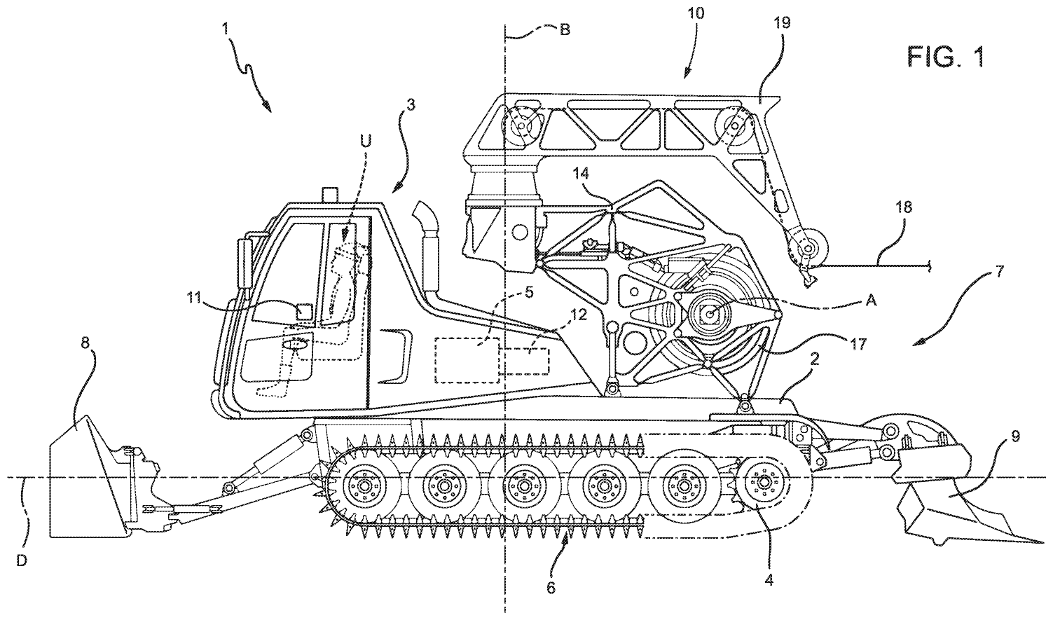

With reference to FIG. 1, a tracked vehicle, in particular a snow groomer, according to an embodiment of the present disclosure is indicated as a whole with reference numeral 1.

The tracked vehicle 1 comprises a frame 2, which extends along a longitudinal axis, a driver's cab 3 and a drive unit 5, for example an internal combustion engine or an electric motor. The driver's cab 3 and the drive unit 5 are housed on the frame 2. The snow groomer 1 is also provided with a pair of tracks 6 and accessory devices 7. The accessory devices 7 comprise a blade 8, supported anteriorly by the frame 2; and a tiller assembly 9, supported posteriorly by the frame 2. The tiller assembly 9 comprises a tiller and a finisher. Furthermore, the tiller assembly 9 can comprise auxiliary tillers (not illustrated in figure) and track setter assemblies (not illustrated in figure) configured to set cross-country skiing trails.

Furthermore, the accessory devices 7 comprise a winch assembly 10.

A power transmission 12 is operatively coupled to the drive unit 5, which provides the power necessary for the functioning of the snow groomer 1, and to the accessory devices 7. The power transmission 12 can be hydraulic or electric or a combination between hydraulic and electric.

The accessory devices 7 can also be called accessories.

It should be appreciated that a tracked vehicle 1 does not necessarily comprise all the accessory devices 7 illustrated above. For example, a tracked vehicle 1 can comprise one or any two of the accessory devices 7 selected from the blade 8, the tiller assembly 9 and the winch assembly 10.

In the driver's cab 3 a user interface 11 is installed, which enables an operator to control the direction of the tracked vehicle 1 and the operation of the accessory devices 7.

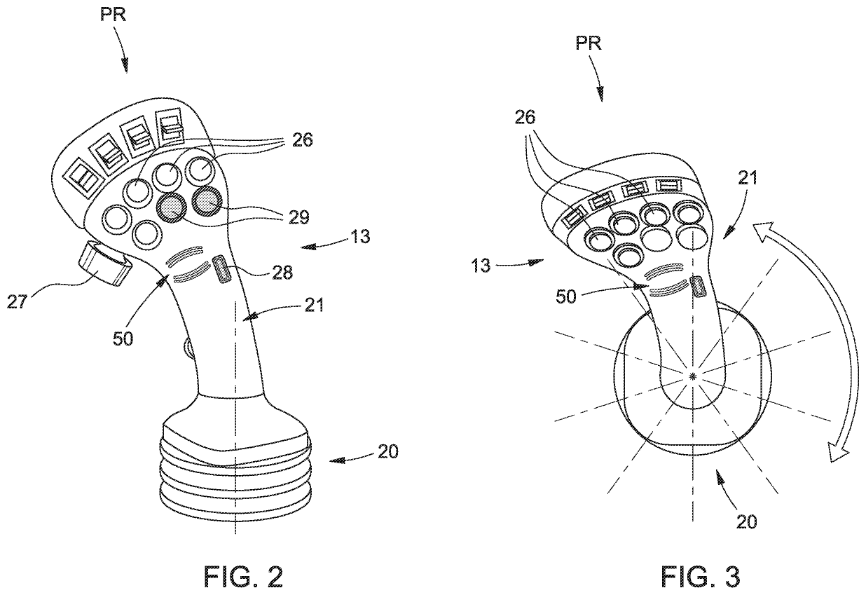

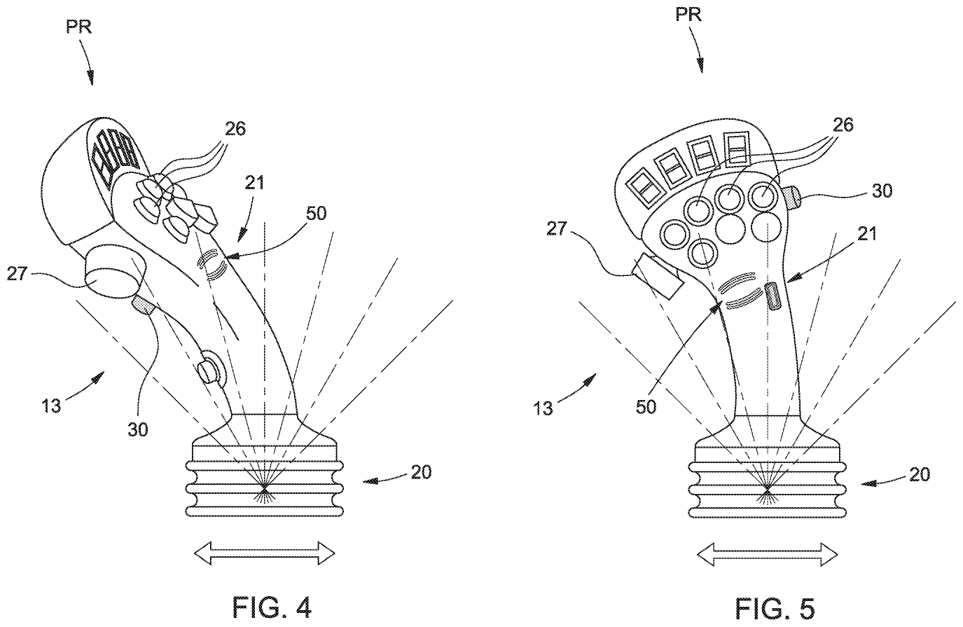

In particular, the user interface 11 comprises a control device and a joystick 13 (FIGS. 2 to 5).

The control device is configured to drive the tracks 6. More precisely, the control device is coupled to the plurality of tracks 6 for driving the advance of the tracked vehicle 1.

The joystick 13 is coupled to the accessory devices 7 configured to drive the movements of the accessory devices 7.

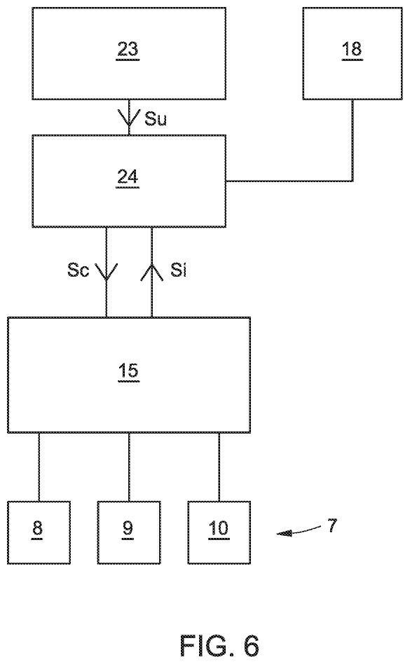

As seen in FIG. 6, the tracked vehicle 1 is provided with a control system 15.

The control system 15 detects operational parameters of the tracked vehicle 1, such as, for example and not exhaustively, the power supplied by the drive unit 5, the power absorbed by each of the accessory devices 7, the position of the blade 8 and of the tiller assembly 9, the position of the winch assembly 10, the advance speed of the snow groomer 1 and drives the drive unit 5 and/or the tracks 6 and/or the accessory devices 7 based on the commands that the control system receives from the user interface 11.

The blade 8 can be raised or lowered. Furthermore, the blade 8 can be rotated such as by lateral inclination or roll, in practice creating a difference in level between the right and left ends of the blade 8 with respect to the level of the tracks 6. Furthermore, the blade 8 can be tilted downward for creating a pitch so as to define an angle of incidence of the blade 8, also called cutting angle. Furthermore, the blade 8 can be positioned perpendicularly or obliquely with respect to the advance direction of the snow groomer 1 (i.e., tilted or moved for defining a yaw). The joystick 13 of the user interface 11 is configured to control the blade 8. The joystick 13 is housed in the driver's cab 3 and enables driving the described pitch, roll and yaw movements of the blade 8.

The tiller assembly 9 is connected to the frame 2 of the tracked vehicle 1 so that the tiller assembly can be rotated, in practice arranging the blade 8 itself perpendicularly or obliquely with respect to the advance direction of the snow groomer 1 itself, raised or lowered, and moved laterally. Furthermore, it is possible to determine a relative angular position of the tiller assembly 9 for defining a cutting angle of the tiller assembly 9 with respect to the mantle of snow. The joystick 13 of the user interface 11 is configured to control the tiller assembly 9 and enables driving the described movements of the tiller assembly 9.

The winch assembly 10 comprises a drum 17 about which a cable 18 is wound and an arm 19. The drum 17 rotates about an axis A and is driven by a motor and defines the force of traction of the cable 18. The arm 19 rotates about an axis B and is driven by an actuator for defining the position of the arm 19 so as to direct the cable 18. The joystick 13 of the user interface 11 is configured to control the winch assembly 10, in particular the force of traction of the cable 18 and the angular position of the arm 19.

With reference to FIGS. 2 to 5, the joystick 13 comprises a base 20 and a lever 21 coupled to the base 20 so that the joystick can be moved, in particular tilted and/or rotated, in any direction with respect to a rest position PR.

The joystick 13 comprises a detector assembly 23 (FIG. 6) configured to detect the movement of the lever 21 with respect to the rest position PR and to emit an output signal Su based on the detected movement.

The tracked vehicle 1 comprises a control unit 24 configured to emit a control signal Sc.

More precisely, the control unit 24 is coupled to the detector assembly 23 configured to receive the output signal Su.

Furthermore, the control unit 24 is coupled to the control system 15 configured to send the control signal Sc to the control system 15 and configured to receive input signals Si from the control system 15.

The control unit 24 is coupled to the accessory devices 7 by the control system 15 configured to control the movements of the accessory devices 7 by the control signal Sc which is sent to the accessory devices 7.

In certain embodiments provided by way of example without thereby losing generality, the control unit 24 is integrated in the control system 15.

In certain embodiments provided by way of example without thereby losing generality, the control unit 24 is housed in the joystick 13.

More precisely, the control unit 24 is configured to emit the control signal Sc based on the output signal Su received and based on a function f, wherein the function f is a non-linear function having parameters that are dynamically adjustable.

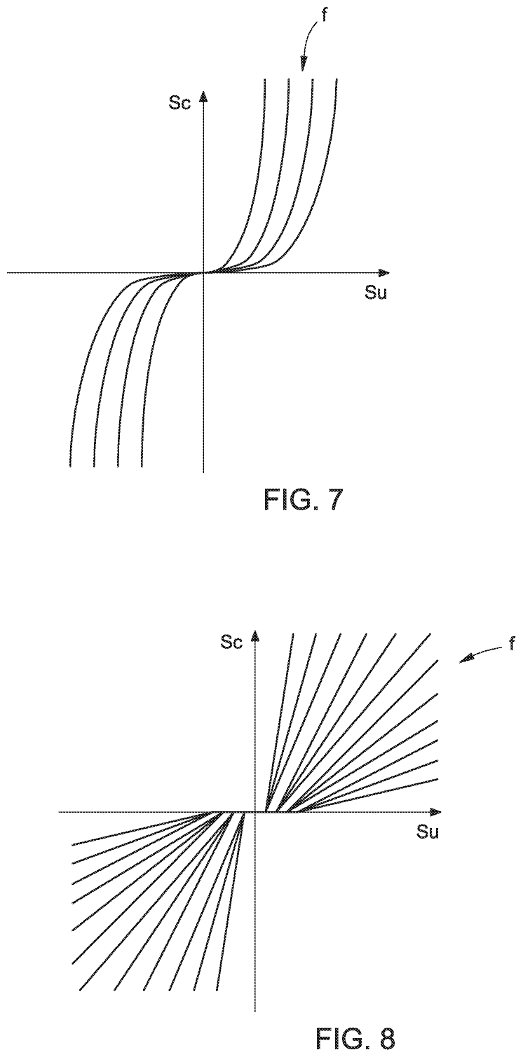

More precisely and with reference to FIG. 7 various forms of functions f alternative between each other are provided. The function f in particular can be a proportional, exponential, progressive or regressive function.

In a particular embodiment, the function f is defined so that the control unit 24 emits the control signal Sc equal to zero or does not emit a control signal Sc if the distance between the position of the lever 13 and the rest position PR is within a designated displacement range; wherein the designated displacement range is dynamically adjustable. In particular, the designated displacement ranges are ranges of angles of inclination and/or angles of rotation. In other words, in this embodiment, the function f is of the type equal to: a*x+k, where x is the variable, and a and k are the parameters, and where k is greater than zero. Put differently, the control signal Sc is obtained by the function f in the following manner: Sc=a*Su+k, where a and k are variable parameters and adjustable by the control unit 24, k is greater than zero and Su is the output signal. Consequently, the control unit 24 controls the joystick 13 by an adjustable deadband. As such, varying k in said function, the deadband increases or decreases. This entails that within a designated or given range of movements of the lever 21, the relative accessory device 7 will not move. This range of movements is adjustable manually by the operator by a selector or automatically by the control unit 24 based on various parameters of the tracked vehicle 1.

More precisely and with reference to FIGS. 5 and 6, the lever 21 can be tilted in any direction with respect to a rest position PR. The control unit 24 is configured to control at least one of the accessory devices 7, by the control system 15, by the control signal Sc so that the accessory device 7 does not move if the angular distance between the position of the lever 21 and the rest position PR is within a range of angles of inclination. Such range of angles of inclination is adjustable manually by the operator by a selector or automatically by the control unit 24 based on various parameters of the tracked vehicle 1.

More precisely and with reference to FIG. 3, the lever 21 can be rotated in any direction with respect to a rest position PR. The control unit 24 is configured to control at least one of the accessory devices 7, by the control system 15, by the control signal Sc so that the accessory device 7 does not move if the angular distance between the position of the lever 21 and the rest position PR is less than a designated or given range of angles of rotation. The designated range of angle of rotation is adjustable manually by the operator by a selector or automatically by the control unit 24 based on various parameters of the tracked vehicle 1.

In an embodiment illustrated by way of example without thereby causing the disclosure to lose generality, the user interface 11 comprises a selector 18 that can be housed on the lever 21 of the joystick 13 or externally thereof in the dashboard of the tracked vehicle 1 or implemented via software and selectable by the user interface for example by a control panel of the tracked vehicle or a touch monitor. The selector 18 is coupled to the control unit 24 and is configured to define at least one of the parameters a and/or k of the function f.

In one of the embodiments, wherein the function f is of the type Sc=a*Su+k, the selector 18 is configured to define k and consequently to define one or more of the designated ranges between the range of angles of rotation and/or the range of angles of inclination. In this way, one or more of the ranges can be adjusted by the operator manually. Accordingly and based on this manual adjustment, each operator can select one or more ranges as preferred based on the personal style of use of the accessories 7 and personal preferences. As such and based on the manual adjustment, it is possible to obviate the wear of the joystick 13 over time.

With reference to FIG. 6, the control unit 24 receives the position of the lever 21 from the detector assembly 23 and emits a control signal Sc based on the detected position and based on the function f. The control unit 24 is coupled to the control system 15, which in turn is coupled to the accessory devices 7 and drives them based on the control signal Sc of the control unit 24. In particular, the control signal Sc can be a signal having linear or progressive or regressive features with respect to the detected position of the lever 21.

With reference to FIGS. 2 to 5, the joystick 13 comprises a plurality of buttons 26 of operation, of mini levers 29, of selector buttons 30 and a potentiometer 27. In an alternative embodiment, not illustrated in the accompanying figure, the joystick comprises a plurality of potentiometers.

In an embodiment, one of the potentiometers adjusts the pulling force of the winch 10 and/or the pressure applied by the tiller assembly 9 on the mantle of snow and/or the speed of rotation of the tiller assembly 9.

In an embodiment of the disclosure, the selector buttons 30 are used for selecting the type of accessory 7 to be operated and controlled. In another embodiment of the disclosure the type of accessory 7 is selected and/or controlled acting on one or more of the buttons 26, of the mini levers 29, of the selector buttons 30 and of the potentiometer 27.

The joystick 13 sends signals or data to the control unit 24 based on the buttons 26 of operation, of the mini levers 29, of the selector buttons 30 and of the potentiometer 27 which were operated and the possible value thereof.

In an embodiment of the present disclosure, the control unit 24 defines the amplitude of one or more of the parameters of the function f, in particular the parameters a and k, based on the buttons pressed by the operator, in particular based on the time that passed from the last time that the operator acted on one among the buttons 26, the mini levers 29, the selector buttons 30 and the potentiometer 27.

In an embodiment, the control unit 24 is configured to vary the type of function f and/or its parameters and, in certain instances, consequently to decrease the amplitude of one or more of the designated ranges of angle of rotation or angle of inclination, based on the time passed from the last command received by one of the buttons 26, of the mini levers 29, of the buttons 30 or of the potentiometer 27 and subsequently to increase the amplitude of one or more of the designated ranges upon the passing of time from the last time that one or more of the buttons 26, of the mini levers 29, of the selector buttons 30 or of the potentiometer 27 was operated.

In certain embodiments, but non-limiting of the present disclosure, the control unit 24 defines the type of function f and its parameters and consequently the amplitude of one or more of the designated ranges of angle of rotation, angle of inclination and distance based on the operation of one or more of the selector buttons 30 that indicates which accessory 7 the joystick 13 is driving.

In a non-limiting embodiment, the type of function f and its parameters and consequently one or more of the designated ranges of angle of rotation and/or angle of inclination is varied depending on the value selected on the potentiometer 27.

In certain embodiments, but non-limiting of the present disclosure, the control unit 24 defines the type of function f and its parameters, and consequently the amplitude of one or more of the designated ranges of angle of rotation and angle of inclination based on the detected speed of movement of the lever 21. In particular the detector assembly 23 sends the positions of the lever 21 both angles of rotation and angles of inclination. The control unit 24 is configured to receive these signals or data relating to the positions and to define the type of function f and its parameters and, consequently, a value of the speed of movement of the lever 21 and to increase the amplitude of one or more of the designated ranges of angle of rotation, angle of inclination if the detected speed of movement of the lever 21 is greater than a threshold value.

In certain embodiments, but non-limiting of the present disclosure, the control unit 24 defines the type of function f and its parameters and consequently the amplitude of one or more of the designated ranges of angle of rotation, angle of inclination and according to the oscillation frequency and/or amplitude of the lever 21.

In particular the detector assembly 23 sends the positions to the lever 21 both angles of inclination, and angles of rotation.

The control unit 24 is configured to receive these signals or data relating to the positions and to define an oscillation frequency of the lever 21 and to increase the amplitude of one or more of the designated ranges of angle of rotation, angle of inclination by the variation of the type of function f and of its parameters if the detected oscillation frequency of the lever 21 is within a range of oscillation frequencies.

In certain embodiments, but non-limiting of the present disclosure, the joystick 13 comprises a sensor 28 of proximity configured to detect the presence of a hand on the lever 21. The sensor 28 can be a pressure sensor or a capacitive sensor or a magnetic sensor or any other type of sensor capable of detecting a hand on it.

The control unit 24 defines the type of function f and its parameters and consequently the amplitude of one or more of the designated ranges of angle of rotation, angle of inclination and based on the presence of a hand on the lever. In certain embodiments, the control unit 24 decreases the amplitude of one or more of the designated ranges when the sensor 28 of presence detects the presence of a hand on the lever 21 of the joystick 13.

In certain embodiments, but non-limiting of the present disclosure, the control unit 24 defines the type of function f and its parameters based on one of the operational parameters of the tracked vehicle 1, such as, for example and not exhaustively, the power supplied by the drive unit 5, the power absorbed by each of the accessory devices 7, the position of the blade 8 and of the tiller assembly 9, the position of the winch assembly 10, the advance speed of the snow groomer 1. In this way the control unit 24 defines also the amplitude of one or more of the designated ranges of angle of rotation, angle of inclination.

In a non-limiting embodiment, the control unit 24 is configured to emit the control signal Sc based on the output signal Su and on the input signal Si, such as one or more of the parameters of the function f are defined based on the input signal Si.

In a non-limiting embodiment, the control unit 24 is configured to select the function f from a plurality of functions f based on the input signal Si.

In certain embodiments, the joystick 13 comprises a light indicator 50 that can be a light, a led or any other element that can be lit on command. In certain embodiments the light indicator 50 is housed on the lever 21. The light indicator 50 is controlled by the control unit 24 and the intensity of the light is adjusted based on the parameters a and k, and on the type of function f. In other words, the intensity of the light is adjusted based on the deadband or the speed of response of the joystick. In another embodiment, the light indicator 50 emits light of different colours and the colour and/or the light intensity of said colour is adjusted based on the parameters a and k, and on the type of function f. In other words, the colour and/or the light intensity is adjusted based on the deadband or on the speed of response of the joystick 13. For example, when the deadband is greater than a designated or given range the joystick 13 can emit a red light while when the deadband is less than a designated or given range the joystick 13 can emit a green light. Furthermore, the light indicator 50 is configured to indicate errors in the joystick 13 and/or malfunctioning. In particular, the light indicator 50 is configured to indicate a state of block of the joystick 13.

In accordance with the present disclosure, the joystick 13 has a deadband within which the joystick does not emit a control signal Sc for the accessories 7. Such deadband defined by the designated ranges of angle of rotation and/or angle of inclination can be adjusted manually or automatically and this enables having a variable deadband based on the conditions of functioning of the tracked vehicle 1 so that it is reduced to the minimum when the operator is actually controlling one of the accessory devices 7 and it is instead increased when the operator is not controlling one of the accessory devices 7, so as to avoid as much as possible involuntary movements of the accessory devices 7 caused by accidental strikes on the lever 21 of the joystick 13 or by vibrations of the tracked vehicle 1 or by wear of the joystick 13 or by other causes. In accordance with the present disclosure, the sensitivity of the joystick 13 is adjusted and this enables having both a relatively excellent sensitivity, when necessary, and an immunity to the involuntary movements.

It should be appreciated that the present disclosure can be subject to variations with respect to the embodiments described above without however departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1-15. (canceled)

16: A tracked vehicle comprising:
a frame extending along a longitudinal axis;
a plurality of tracks;
an accessory device comprising at least one of a blade, a tiller assembly and a winch assembly;
a user interface comprising:
a control device operably connected to the plurality of tracks and operable to control an advance of the tracked vehicle; and
a joystick operably connected to the accessory device and operable to control movements of the accessory device, the joystick comprising:
a lever configured to enable the joystick to be moved in different directions with respect to a rest position, and
a detector assembly configured to:
detect a movement of the lever with respect to the rest position, and
emit an output signal based on the detected movement; and
a control unit operably connected to the accessory device and operable to control at least a movement of the accessory device by a control signal sent to the accessory device, the control unit operably connected to the detector assembly of the joystick and operable to receive the output signal and output the control signal according to a first function and the output signal.

17: The tracked vehicle of claim 15, wherein the first function is a non-linear function.

18: The tracked vehicle of claim 15, wherein a parameter of the first function is adjustable based on a further signal received.

19: The tracked vehicle of claim 15, wherein the first function is defined such that the control unit outputs the control signal equal to zero if a distance between a position of the lever and the rest position is within a dynamically adjustable displacement range.

20: The tracked vehicle of claim 15, wherein the first function is defined such that the control unit does not output the control signal if a distance between a position of the lever and the rest position is within a dynamically adjustable displacement range.

21: The tracked vehicle of claim 15, wherein:
the lever is coupled to a base such that the lever is tiltable and rotatable in different directions with respect to the rest position, and
the control unit is configured to control the accessory device by the control signal such that the accessory device does not move if an angular distance between a position of the lever and the rest position is within at least one of a dynamically adjustable range of angles of inclination and a dynamically adjustable range of angles of rotation.

22: The tracked vehicle of claim 15, further comprising a selector, wherein a parameter of the first function is adjustable via the selector.

23: The tracked vehicle of claim 15, wherein the control signal comprises a signal having at least one of a progressive characteristic and a regressive characteristic with respect to a detected distance from the rest position.

24: The tracked vehicle of claim 15, wherein a parameter of the first function is defined by the control unit based on a detected speed of movement of the lever.

25: The tracked vehicle of claim 24, wherein the control unit is configured to increase an amplitude of a range if the detected speed of movement of the lever is greater than a threshold value.

26: The tracked vehicle of claim 15, wherein a parameter of the first function is defined by the control unit based on an oscillation frequency of the lever.

27: The tracked vehicle of claim 26, wherein the control unit is configured to increase an amplitude of a range if a detected oscillation frequency of the lever is within a range of oscillation frequencies.

28: The tracked vehicle of claim 15, wherein the joystick comprises at least one of a button and a mini lever, and a parameter of the first function is defined by the control unit based on an activation of at least one of the button and the mini lever.

29: The tracked vehicle of claim 15, wherein the joystick is configured to detect a presence of any hands on the lever and a parameter of the first function is defined by the control unit based on a detection of the presence of a hand on the lever.

30: The tracked vehicle of claim 15, wherein the joystick comprises an accessory selector to select a type of accessory to be operated, and a parameter of the function is defined by the control unit based on a value of the accessory selector that indicates which accessory device is controlled by the joystick.

31: The tracked vehicle of claim 15, wherein the joystick comprises a light indicator and at least one of an intensity of the light indicator and a color of the light indicator is adjustable based on a parameter of the first function.

32: A method of controlling an accessory device of a tracked vehicle comprising two tracks, the accessory device comprising at least one of a blade, a tiller assembly and a winch assembly, and a user interface comprising a control device operably connected to the plurality of tracks to control an advance of the tracked vehicle, and a joystick operably connected to the accessory device to control movements of the accessory device and comprising a lever moveable in different directions with respect to a rest position, the method comprising:
detecting a movement of the lever with respect to the rest position,
emitting an output signal based on the detected movement; and
controlling a movement of the accessory device based on a first function and the output signal, wherein the first function is a non-linear function and a parameter of the first function is adjustable based on a further signal.

33: The method of claim 32, further comprising emitting a control signal configured to move the accessory device if a distance between a lever position and the rest position is greater than a dynamically adjustable range of distances.

34: The method of claim 33, wherein the lever is coupled to a base such that the lever is tiltable and rotatable in different directions with respect to the rest position, and further comprising emitting the control signal if an angular distance between the lever position and the rest position is greater than at least one of an adjustable range of angles of inclination and an adjustable range of rotation.

35: The method of claim 32, wherein the joystick comprises at least one of a button, a mini lever and an accessory selector which operate the accessory device, and further comprising defining the parameter of the first function based on any of: a detected speed of movement of the lever, an oscillation frequency of the lever, an activation of the button, a detection of a hand on the lever, a value of the accessory selector that indicates which accessory device the joystick is controlling, and a value of a selector regulator.
